(19) United States
(12) Patent Application Publication
(10) Pub. No.: US 2023/0227275 A1
(43) Pub. Date: Jul. 20, 2023

(54) MOBILE TRANSPORT CONTAINER FOR A SORTING DEVICE AND METHOD FOR OPENING AND/OR CLOSING A TRANSPORT CONTAINER

(71) Applicant: BÖWE SYSTEC GmbH, Augsburg (DE)

(72) Inventors: Stephan HAUKE, Augsburg (DE); Josef BATZER, Stadtbergen (DE); Ronald CELESTE, Kühlenthal (DE)

(73) Assignee: BÖWE SYSTEC GmbH, Augsburg (DE)

(21) Appl. No.: 18/096,970

(22) Filed: Jan. 13, 2023

(30) Foreign Application Priority Data
Jan. 14, 2022 (DE) 10 2022 100 782.0

(51) Int. Cl. B65G 47/96; B65G 47/38

(52) U.S. Cl. CPC B65G 47/967; B65G 47/38

(57) ABSTRACT

A transport container for a sorting device includes a support frame, a flap pivotally arranged on the frame, and an adjusting device which is coupled to the flap, to move the flap between a transport position for transporting an object and a dropping position for dropping the object. The adjusting device has a lever coupled to the flap. In order to be able to open and close the transport container reliably and to prevent the opened flap from swinging afterward, as well as to ensure as synchronous a movement of the flaps as possible in the case of several flaps, a cam plate rotatably mounted on the frame and having at least one guide surface is provided, on which the lever is guided during movement of the flap from the transport position into the dropping position and/or during an entire return movement from the dropping position into the transport position.

### FIELD OF THE INVENTION

The invention relates to a mobile transport container for a sorting device, a sorting device comprising such a transport container, and a method for opening and/or closing such a transport container.

### BACKGROUND

Such transport containers can be used, for example, in so-called split tray sorters. These are sorting devices for piece goods, in particular shipping goods, such as textiles or books. The transport containers of split tray sorters have at least one flap, usually two or four flaps, which are hinged to a support frame and can be moved between a closed transport position and an open dropping position. The piece goods to be transported are placed by machine or manually at a loading station on top of the flaps being arranged in the transport position, in which the flaps are closed. The transport containers are moved along a transport path, which is designed in particular as an endless loop, by means of a drive, for example a belt drive, to a dropping station. At the dropping station, the flaps are brought into the dropping position, in particular swung open, and the piece goods on them fall by gravity into a collecting container, for example a shipping carton, which is placed at the dropping station under the passing transport container. In the case of a split tray sorter, the collecting containers are placed in particular directly below the passing transport containers, with the piece goods located on the flaps, which are specially designed as flaps forming a bottom, falling essentially vertically downwards into the collecting container at the dropping station. After the piece goods have been discharged, the flaps of the transport container are returned to their transport position so that the transport container can be reloaded with piece goods. Several such transport containers can be arranged along the transport path to transport piece goods from a loading station to a predetermined dropping station.

From EP 1 448 464 B1 a device for transporting and controlled unloading of a load is known, which can be used in a transport and sorting system for transporting and sorting goods, such as shipping or postal goods. The known device comprises a closed transport path in the form of an endless loop with a guide for at least one transport container movable along the transport path and a drive device for moving the transport container or the transport containers along the transport path. Loading and unloading stations are arranged along the transport path. At the loading stations, the transport containers are filled with goods to be sorted. The transport containers filled with the goods can be unloaded at selected unloading stations. For loading and unloading, the transport containers have a support plate formed by a first and a second tilting trough, which is used to receive the goods. The tilting troughs are attached to a frame so that they can be pivoted about parallel tilting axes and can be pivoted between a transport position, in which the tilting troughs form a flat support plate for receiving the goods, and a downwardly suspended unloading position. For unloading the transport containers at an unloading station of the transport path, the tilting troughs can be tilted into their unloading position, whereby the goods lying on the support plate fall downwards into receiving containers arranged below the transport containers due to gravity. To ensure that when the tilting troughs are swiveled from their transport position to their unloading position — and vice versa — both tilting troughs are swiveled at the same time, a coupling is provided in the known device which is able and suitable to transmit a tilting movement of the first tilting trough to the second tilting trough. The coupling can have a coupling rod that is connected to both tilting troughs and enables the tilting troughs to be swiveled eccentrically with respect to their tilt axes.

The coupling mechanism known from this prior art for simultaneous opening or closing of the tilting troughs by means of a coupling rod attached to both tilting troughs has proven to be error-prone, especially when closing the tilting troughs, and maintenance-intensive during operation.

A transport container for a sorting device is known from WO 2021/ 043 760 A2, which can be moved along a conveyor track and has a supporting frame with at least one rotatably mounted supporting shell, in particular a first supporting shell and a second supporting shell following the first supporting shell in the conveying direction of the transport container, the at least one supporting shell being rotatably movable by an adjusting device between a substantially horizontal transport position for transporting a load and a substantially vertical tilting position for discharging the load, and the adjusting device has an adjusting lever connected to the supporting shell, in particular a first adjusting lever connected to the first supporting shell and a second adjusting lever connected to the second supporting shell, the adjusting lever, in particular in each case the first adjusting lever and/or the second adjusting lever, being arranged in the transport position and/or in the tilting position in an over-center position forming a locking position. To transfer the at least one supporting shell from the transport position to the tilting position, a center of gravity of the supporting shell and/or a center of gravity of an adjusting lever connected to the supporting shell is first raised and then lowered. Similarly, to move out of the tilt position, the supporting shells must first be opened slightly further before they can be moved upwards into the transport position. In this way, in the transport position, the first supporting shell and the second supporting shell can be secured against unintentional opening of the supporting shells caused by a weight force of the load, and in the tilt position, the locking of the first supporting shell and the second supporting shell prevents the supporting shells from swinging back after opening. However, with this arrangement, there is a risk of jamming of the supporting shells in the transport position or the tilt position because the adjusting lever or levers cannot be moved out of the over-center position if, for example, an increased frictional force or other malfunction prevents a corresponding movement of an adjusting lever out of its over-center position.

### SUMMARY

On this basis, one aspect of the invention relates to providing a transport container for a transport system for transporting and sorting piece goods, in particular shipping goods and postal goods, which has at least one pivotable flap and ensures reliable and less error-prone opening and closing of the flaps. The aim is to ensure that the flaps move as synchronously as possible and to prevent the opened flap from swinging when the at least one flap is opened from its transport position to its dropping position.

Accordingly, disclosed herein are a transport container and a method for opening and/or closing a transport container. Preferred embodiments of the transport container and the method are also disclosed herein.

The transport container according to the invention, which in particular can be arranged to be movable along a transport path of a sorting device, in particular a split tray sorter, in a predetermined transport direction, has at least one flap which is pivotably articulated on a support frame and can be pivoted between a closed transport position, in which the flap forms a support plate for receiving piece goods, and an open dropping position for unloading the goods. The at least one flap is preferably arranged on the support frame so as to be pivotable about a swivel axis, which is in particular perpendicular to the intended transport direction of the transport container. For pivoting the at least one flap between the transport position and the dropping position, an adjusting device coupled to the flap is provided, which comprises at least one adjusting lever, which is, in particular at one end of the adjusting lever, connected in an articulated manner to the at least one flap. A cam plate with at least one guide surface is rotatably mounted on the support frame, wherein the at least one adjusting lever, in particular another end or a guide section of the at least one adjusting lever is guided on the guide surface of the cam plate during the entire movement of the flap from the transport position into the dropping position and/or during an entire return movement from the dropping position into the transport position.

By guiding the at least one adjusting lever on the guide surface of the cam plate during the entire movement of the flap from the transport position to the dropping position and/or during the entire return movement, the flap is guided securely over the entire radius of movement without any risk of twisting or jamming. This means that the movement of the flap is less prone to error both during opening and closing. When the flap is opened, swinging back of the flap is avoided, since the flap is safely guided by the guide of the adjusting lever on the guide surface of the cam plate during the entire opening movement and even when the open end position (dropping position) is reached or held in the end position.

The guide surface of the cam plate is expediently arranged and shaped on the cam plate in such a way that the adjusting lever is guided on the one guide surface of the cam plate over the entire radius of movement both when the flap is opened and when the flap is closed. However, it is also possible to provide two continuous guide surfaces or guide surface sections on the cam plate, one guide surface being provided for guiding the adjusting lever when the flap is opened and the other guide surface or guide surface section being provided for guiding the adjusting lever when the flap is closed.

In a preferred embodiment, the transport container comprises a first flap and a second flap, which are each arranged on the support frame such that they can be pivoted about a (separate) swivel axis, which is in particular perpendicular to the intended transport direction of the transport container, the first flap being assigned a first adjusting lever and the second flap being assigned a second adjusting lever, and the cam plate having a first guide surface for guiding the first adjusting lever and a second guide surface for guiding the second adjusting lever. The design of the transport container with two flaps arranged one behind the other in the transport direction increases the loading surface of the transport container in the transport position without the dead weight of the individual flaps becoming too heavy, which can be disadvantageous when opening the flap because too much dead weight of the flap promotes swinging back when the end position is reached.

The transport container according to the invention may also comprise more than two flaps. For example, in one embodiment it is provided that the transport container comprises two pairs of flaps arranged next to each other in a direction perpendicular to the transport direction, i.e. a total of four flaps, wherein the flaps arranged next to each other are mounted rotatably about a common axis which is perpendicular to the transport direction. When in the following reference is made to a flap, in particular to at least one flap, this also refers to several flaps of a transport container. Accordingly, only one flap can be meant when (several) flaps of a transport container are referred to.

If the transport container comprises several flaps, in particular a first and a second flap, each flap is assigned an adjusting lever and each adjusting lever is assigned a guide surface on or at the cam plate. In particular, the cam plate thus has a first and a second guide surface in the case of two flaps. Preferably, the two guide surfaces are shaped in such a way that the movement of the two flaps is synchronous. However, asymmetrical arrangement or shaping of the two guide surfaces on or at the cam plate can also be used to realize asynchronous motion sequences. For example, it is possible to create a motion sequence in which one of the two flaps opens or closes earlier than the other flap.

If the transport container comprises two pairs of flaps arranged next to each other perpendicular to the transport direction and having a first and a second flap, each pair of flaps is assigned a cam plate and each flap is assigned an adjusting lever and each adjusting lever is assigned a guide surface on or at the assigned cam plate, each cam plate comprising two guide surfaces. The two cam plates can, for example, be arranged laterally on both sides of the transport container.

The cam plate is preferably preloaded in a basic position by a spring element, with the at least one flap being in its transport position in the basic position of the cam plate. This enables the transport container to move back automatically into its transport position after unloading by dropping the piece goods.

In the transport position, the cam plate is preferably held in its basic position by a securing element, in particular by a pretensioned latch. This ensures that the flap is securely fixed in its transport position and cannot open unintentionally. To open the flap, the securing element is unlocked in a manner described in detail below, causing the flap to move automatically to its dropping position under the force of gravity. To release the securing element, a release element is expediently provided, which is arranged in particular on the transport path of the sorting device and which releases the securing element when the transport container moves past the release element in the transport direction. The release element is arranged in particular upstream of a drop position of the transport path of the sorting device, at which position the transport container drops a transported piece goods by moving the at least one flap or each flap into the dropping position. For this purpose, the release element is preferably moved by an actuator from a passive normal position into an active functional position, in which the release element engages in the transport path and acts on the securing element to release it. The actuator can be magnetically actuated, for example. The release element is expediently designed as a movable bolt that can be moved back and forth by the actuator between the passive normal position and the active functional position.

In a preferred embodiment, the at least one adjusting lever, in particular the first adjusting lever and the second adjusting lever, contains a guide element which is expediently designed as a guide roller. The guide element of the adjusting lever or each adjusting lever is in contact with the associated guide surface of the cam plate, in particular the first guide surface or the second guide surface, during the entire movement of the flap associated with the adjusting lever, in particular the first flap and/or the second flap, from the transport position to the dropping position and/or during the entire return movement. The guide element is arranged, for example, on a guide arm of the or each adjusting lever. The guide element ensures safe and low-noise guidance of the adjusting lever on the cam plate. To further reduce noise development, the guide element can be designed as a guide roller with an elastic circumferential surface, e.g. with a rubberized circumference.

The at least one guide surface of the cam plate, in particular the first guide surface and the second guide surface, is expediently formed by a protrusion or a recess on the surface of the cam plate. However, the guide surface may also be formed on the outer periphery of the cam plate. A formation of the or each guide surface on a recess of the cam plate, in particular in a clearance on the surface of the cam plate, has the advantage that the associated adjusting lever, and in particular the guide element of the adjusting lever, comes to rest securely against the guide surface and that the adjusting lever is thereby securely mounted in the recess on the surface of the cam plate and cannot slip out. Therefore, the at least one guide surface, in particular the first guide surface and the second guide surface, is preferably part of a clearance or an opening in the cam plate.

Particularly preferably, the at least one guide surface, in particular the first guide surface and the second guide surface, has a guide area and at least one holding area, the guide area in particular being curved, for example slightly convexly curved, and the holding area expediently being part-circular, in particular semicircular. In this case, the holding area is preferably set back with respect to the guide area. During the movement of the at least one flap from the transport position into the dropping position, or vice versa, the associated adjusting lever, in particular the guide element of the adjusting lever, rests against the guide area of the guide surface. In the end positions, i.e. in particular in the transport position and/or in the dropping position, the guide element of the adjusting lever is expediently located in a holding area, where the guide element, for example a guide roller, bears against the holding area of the guide surface over a substantial portion of its circumference, which is preferably at least half of the circumference.

This ensures, on the one hand, that the adjusting lever is securely guided on the guide area of the associated guide surface during the entire movement of the associated flap while the cam plate is rotating and, on the other hand, that the adjusting lever can be securely held in the holding area of the guide surface when an end position (transport position or dropping position) is reached in which the rotation of the cam plate is stopped. The holding area is expediently shaped in such a way that the guide element of the adjusting lever rests against the holding area over a certain circumference, which is preferably at least half of its circumference, when the flap and the associated adjusting lever are in an end position (transport position or dropping position). For this purpose, the holding area of the guide surface can, for example, be part-circular, in particular semicircular or three-quarter-circular.

For moving the at least one flap back from the dropping position into the transport position, a sliding block control with a sliding block is provided, which cooperates with a stop element arranged on the cam plate. The sliding block is expediently arranged on the transport path of the sorting device, in particular downstream of a drop position at which the transport container drops the transported piece good by moving the or each flap into the dropping position. When the emptied transport container moves past the sliding block downstream of the discharge position, the stop element of the cam plate comes into contact with a stop surface of the sliding block, causing the cam plate to rotate and the transport container to be returned to its transport position. For this purpose, the stop element is preferably arranged eccentrically on the cam plate. For this purpose, the sliding block expediently comprises a ramp with a stop element inclined or curved to a horizontal plane, against which the stop element of the cam plate comes into contact when the transport container moves past the sliding block in the intended transport direction. The interaction of the sliding block and the stop element thus causes the cam plate to rotate when the transport container passes the sliding block.

In the method according to the invention for opening and/or closing a transport container for a sorting device, in particular for a split tray sorter, the transport container is moved from a transport position for transporting a piece good into a dropping position for dropping the piece good or back, in that a cam plate, which is rotatably mounted on a support frame and has at least one guide surface, is set in rotation, as a result of which at least one flap which is arranged pivotably on the support frame and is coupled to an adjusting lever, in particular is connected directly or in an articulated manner, is opened or closed, the adjusting lever being guided on the guide surface during the entire movement of the flap from the transport position into the dropping position and/or during the entire return movement from the dropping position into the transport position.

The cam plate is mounted on the support frame so that it can rotate about an axis of rotation and is preferably pretensioned in a basic position in which the flap is in its transport position and is expediently locked in this basic position. The pretensioning is realized, for example, by means of a tensioning or spring element which is fastened eccentrically at one end to the cam plate and at another end to the support frame. The cam plate is locked in its basic position, for example, by a preloaded latch that engages in a latching groove on the cam plate when the cam plate is in its basic position.

To open the transport container, the locked cam plate is unlocked, for example by releasing the latch, whereby the cam plate is automatically set in rotation in a first direction of rotation due to the pretension and the at least one flap is moved from the transport position to the dropping position due to the coupling of the flap with the at least one adjusting lever and the guidance of the adjusting lever on the associated guide surface. The automatic rotation of the cam plate in the first direction of rotation is thereby initiated by the pretension, which transmits a rotational momentum to the cam plate in the first direction of rotation, and is supported by gravity by the dead weight of the flap and the load of the piece good located thereon. This ensures that the flap automatically moves into the dropping position as soon as the cam plate is unlocked.

To close the transport container, the cam plate is preferably rotated in a second direction of rotation opposite to the first direction of rotation by a sliding block engaging with an eccentric stop element, as a result of which the at least one flap is moved from the dropping position into the transport position due to the coupling with the associated adjusting lever and the guidance of the adjusting lever on the associated guide surface. The stop element of the cam plate preferably remains in engagement with the sliding block until the cam plate has reached its basic position and has been locked there. This ensures that the cam plate can be moved safely to its basic position against the angular momentum generated by the preload and that the flap is held safely in the transport position once it has reached its transport position.

Both when opening and closing the transport container, the adjusting lever is guided securely on the assigned guide surface of the cam plate, with the guidance being given during the entire radius of movement of the cam plate or the flap coupled to the adjusting lever.

The transport container according to the invention can advantageously be used in transport and sorting systems for piece goods, in particular for transporting and sorting shipping or postal goods, which comprise a transport path and at least one transport container movable along the transport path in a predetermined transport direction, the transport container or containers being set in motion along the transport path by a drive and at least one transport container being a transport container according to the invention. It is expedient that the transport path is designed as an endless loop.

The transport and sorting system expediently has a guide and drive device for guiding and driving the at least one transport container. The guide and drive device can be designed, for example, as a belt or chain drive, whereby the transport containers that can be moved along the transport path are connected to the belt or chain set in motion by a motor. For guiding the transport containers, at least one guide rail is expediently provided in the transport and sorting system. The transport container expediently has guide rollers for guidance on the guide rail.

At least one loading station and one unloading station are arranged on the transport path of the transport and sorting system. In the loading station, the transport containers can be loaded with the goods to be transported and the transport containers can unload the goods into a receiving container at the unloading station by opening the transport container at the unloading station by moving at least one flap into its dropping position.

A split tray sorter according to the invention comprises at least one, preferably several, of the transport containers according to the invention. The transport containers are moved along a transport path, in particular formed as an endless loop, of the split tray sorter. At a loading station, the piece goods to be transported are placed by machine or manually on the upper side of the one or more flaps, which are designed as a bottom flap or form a bottom, of the transport container arranged in the transport position. The transport containers are then moved to a dropping station at which the flaps are brought into the dropping position, in particular swung open, as a result of which the piece goods on them fall by gravity and essentially vertically into a collecting container placed directly below the passing transport containers. In this respect, the split tray sorter differs in particular from a tilt sorter, in which a transport container or the deposit of a transport container for discharging the piece goods is tilted to the right and/or left with respect to the transport direction of the transport container, as a result of which the piece goods are tilted into collecting containers arranged to the right and/or left of the transport container. After the piece goods have been dropped at the dropping station of the split tray sorter, the flaps are closed again and guided to the loading station to receive a new piece good.

### BRIEF DESCRIPTION OF THE DRAWINGS

These and other advantages and features of the invention are apparent from the example embodiment described in more detail below with reference to the accompanying drawings. The drawings show:

FIG. 1A: Side view of a transport container according to the invention in a transport position T with the flaps closed, wherein the transport container includes an adjusting device and a cam plate, and the view of the transport container is shown facing an outside of the cam plate;

FIG. 1B: Side view of the transport container of FIG. 1A looking at an inner side of the cam plate;

FIG. 1C: Detailed view of the adjusting device of the transport container of FIG. 1A;

FIG. 1D: Detailed view of the adjusting device of the transport container in the viewing direction of FIG. 1B;

FIGS. 2A-2E: Illustration of the steps for opening the flaps of the transport container of FIGS. 1A and 1B from the transport position T (FIG. 2A) to a dropping position A (FIG. 2E), wherein the transport container is shown in a side view with the viewing direction of FIG. 1A;

FIGS. 3A-3E: Illustration of the steps for opening the flaps of the transport container of FIGS. 1A and 1B from the transport position T (FIG. 3A) to a dropping position A (FIG. 3E), wherein the transport container is shown in a side view with the viewing direction of FIG. 1B;

FIGS. 4A-4E: Illustration of the steps for closing the flaps of the transport container of FIGS. 1A and 1B from the dropping position A (FIG. 4A) back to the transport position T (FIG. 4E), wherein the transport container is shown in a side view with the viewing direction of FIG. 1A; and

FIGS. 5A-5E: Illustration of the steps for closing the flaps of the transport container of FIGS. 1A and 1B from the dropping position A (FIG. 5A) back to the transport position T (FIG. 5E), wherein the transport container is shown in a side view with the viewing direction of FIG. 1B.

### DETAILED DESCRIPTION

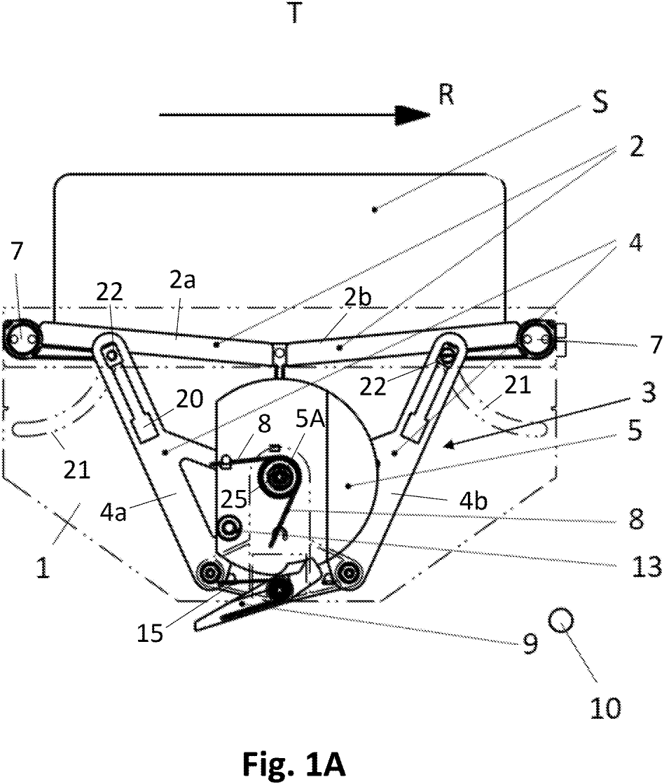

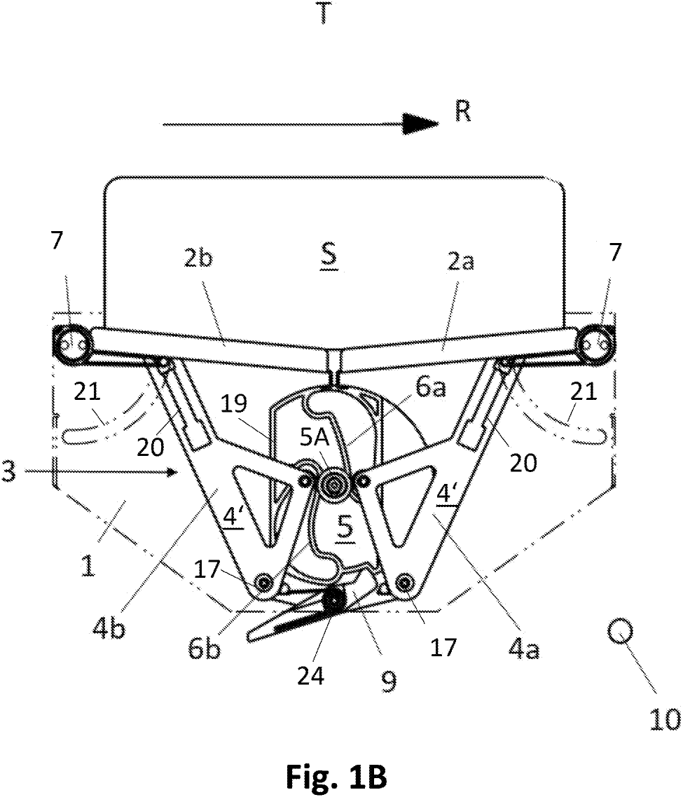

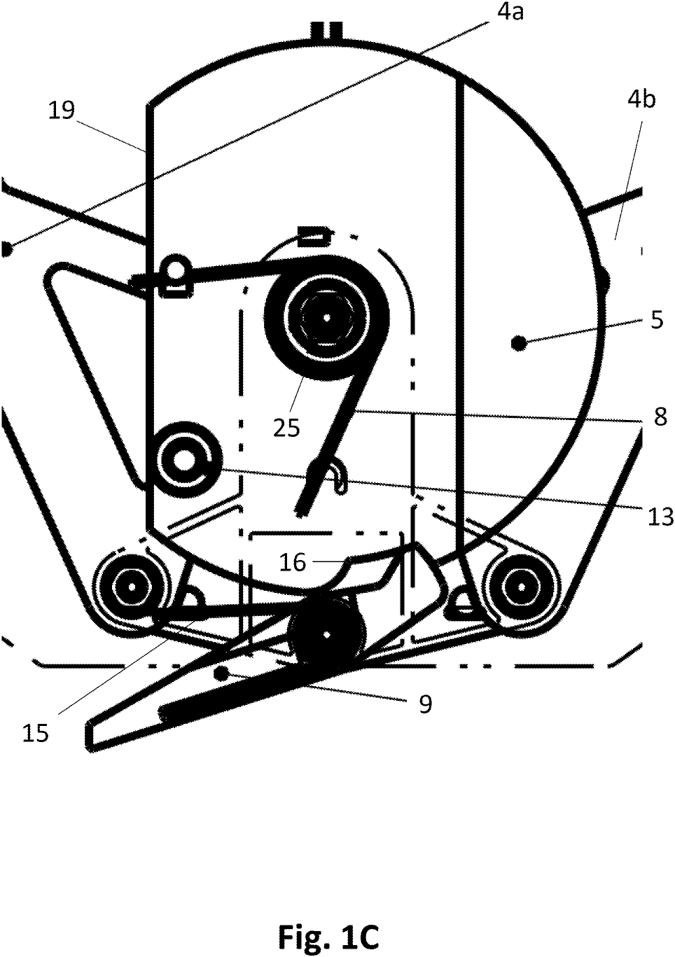

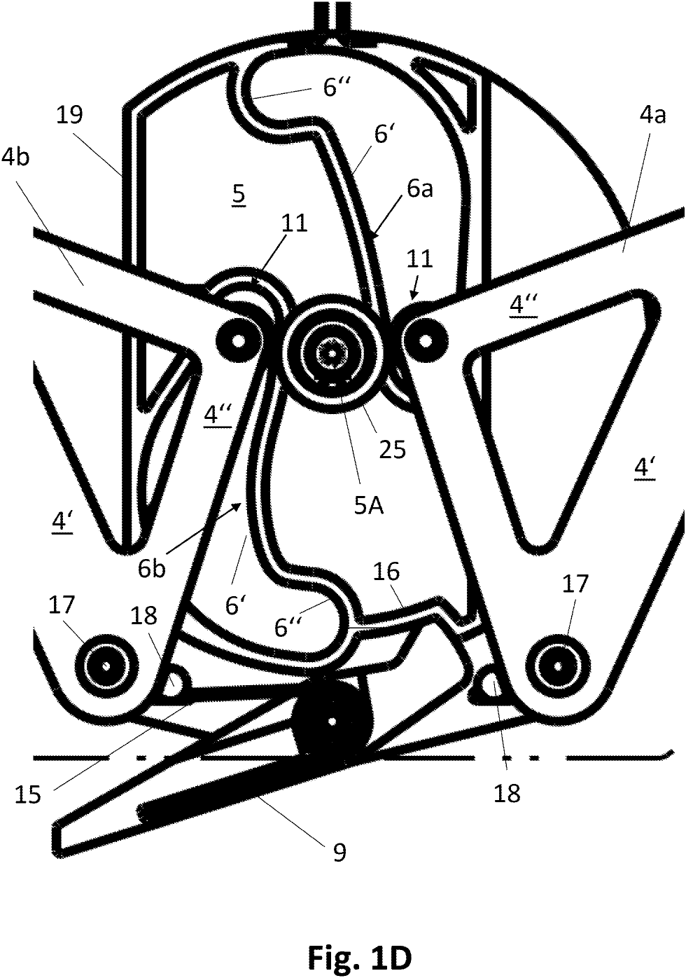

FIGS. 1A and 1B show a preferred embodiment of a transport container according to the invention, with FIGS. 1A and 1B showing the transport container in a side view in different viewing directions and FIGS. 1C and 1D showing detailed representations of the adjusting device of the transport container. The viewing direction of FIGS. 1A and 1C is directed from the outside to the inside in a side view of the transport container, and the viewing direction of the illustrations of FIGS. 1B and 1D is directed in the opposite direction to this viewing direction, namely from the inside to the outside, i.e. rotated by 180° with respect to the viewing direction of FIGS. 1A and 1C.

The transport container shown in FIGS. 1A and 1B comprises a support frame 1 with a side wall shown in dashed lines in FIGS. 1A and 1B and two flaps 2, namely a first flap 2a and a second flap 2b, pivotably arranged on the support frame 1. The transport container is arranged to be movable along a transport path of a transport and sorting system in a transport direction R. The two flaps 2a, 2b, which are also referred to jointly below by the reference sign 2, are each hinged to the support frame 1 so as to be pivotable about swivel axes 7. The two flaps 2 can be pivoted between a transport position T shown in FIGS. 1A and 1B and a dropping position A. In the transport position T, the two flaps 2 are at least approximately in a horizontal position and form a support surface for receiving a piece good S.

Each of the two flaps 2 is hingedly connected to an adjusting lever 4a, 4b associated with the respective flap 2a, 2b, wherein a first adjusting lever 4a is associated with the first flap 2a and a second adjusting lever 4b is associated with the second flap 2b. The adjusting levers 4a, 4b each comprise a longitudinal portion 4′ extending between an upper end and a lower end of the respective adjusting lever 4a, 4b, and a triangular guide portion 4″ formed on the respective longitudinal portion 4′ of the adjusting levers 4a, 4b. In the region of the upper end, the longitudinal section 4′ of each adjusting lever 4a, 4b has a straight elongated hole 20 running along the longitudinal section 4′. A pin 22 engages in this elongated hole 20, which pin 22 is attached to the underside of the flap 2a, 2b associated with the respective adjusting lever 4a, 4b. The pin 22 arranged on the underside of each flap 2a, 2b is further guided in an upper, curved elongated hole 21 of the support frame 1. At the lower end of the longitudinal section 4′ of each adjusting lever 4a, 4b, a guide pin 17 is further arranged which engages in a further, lower elongated hole 18 on the support frame 1. Through this arrangement, the first adjusting lever 4a is hingedly coupled to the first flap 2a and the second adjusting lever 4b is hingedly coupled to the second flap 2b.

A guide element in the form of a guide roller 11 is arranged at the corner of the triangular guide section 4″ of each adjusting lever 4a, 4b facing the cam plate 5 in FIG. 1B. The guide rollers 11 expediently have a noise-absorbing elastic surface on their outer circumference, for example a rubber or plastic coating.

Below the two flaps 2a, 2b, a cam plate 5 is arranged on the support frame 1 so as to be rotatable about an axis of rotation 5A. For this purpose, the cam plate 5 contains a shaft 25 running along the axis of rotation 5A, which protrudes on the outside of the cam plate 5 above its surface. The axis of rotation 5A of the cam plate 5 runs parallel to the swivel axes 7 of the two flaps 2 and is at least approximately symmetrical to these two swivel axes 7. The cam plate 5 is approximately three-quarter-circular in shape and has a flattened section at the side as well as an outer side and an inner side, the outer side shown in FIG. 1A facing outwards laterally on the transport container and the inner side shown in FIG. 1B facing inwards. The cam plate 5 can also be designed as a circular plate. On the outside of the cam plate 5 shown in FIG. 1A, a stop element 13 in the form of a pin is arranged, which projects above the outside surface of the cam plate 5 and is eccentric to the axis of rotation 5A.

On its inner side, which can be seen in the view of FIG. 1B, the cam plate 5 has two recesses which are approximately banana-shaped and spaced apart from one another and whose side surfaces each form a guide surface 6a, 6b. Here, a first guide surface 6a is associated with the first adjusting lever 4a, which is hinged to the first flap 2a, and a second guide surface 6b is associated with the second adjusting lever 4b, which is hinged to the second flap 2b. The guide roller 11 of the first adjusting lever 4a is in contact with the first guide surface 6a of the cam plate 5 and, correspondingly, the guide roller 11 of the second adjusting lever 4b is in contact with the associated second guide surface 6b of the cam plate 5, as can be seen in FIGS. 1B and 1D.

The guide surfaces 6a, 6b are each composed of three sections, namely a first holding section 6″ positioned at the top of the first guide surface 6a and at the bottom of the second guide surface 6a in FIGS. 1B and 1D, an adjoining guide section 6′ and a further holding section positioned at the bottom of the first guide surface 6a and at the top of the second guide surface 6a in FIGS. 1B and 1D. The guide section 6′ is convexly curved and the holding sections 6″ are part-circular, in particular semicircular or three-quarter-circular, as can be seen in FIG. 1D. The first holding section 6″ is set back in relation to the adjoining curved guide section 6′.

A groove-shaped notch 16 is provided on the outer circumference of the cam plate 5. In the transport position T shown in FIGS. 1A and 1B, a securing element pretensioned by means of a spring element 15, which is designed as a latch 9 attached to the support frame 1 so as to be rotatable about an axis of rotation 24, engages in the notch 16, as a result of which the cam plate 5 is held in a basic position, which is shown in FIGS. 1A and 1B.

The cam plate 5 is pretensioned in the basic position by means of a tensioning or spring element 8. In the embodiment shown, the tensioning or spring element 8 is formed by an elastic band which is attached to the outside of the cam plate 5 at two eccentrically arranged attachment points and is guided under tension over the projecting shaft 25 of the cam plate 5.

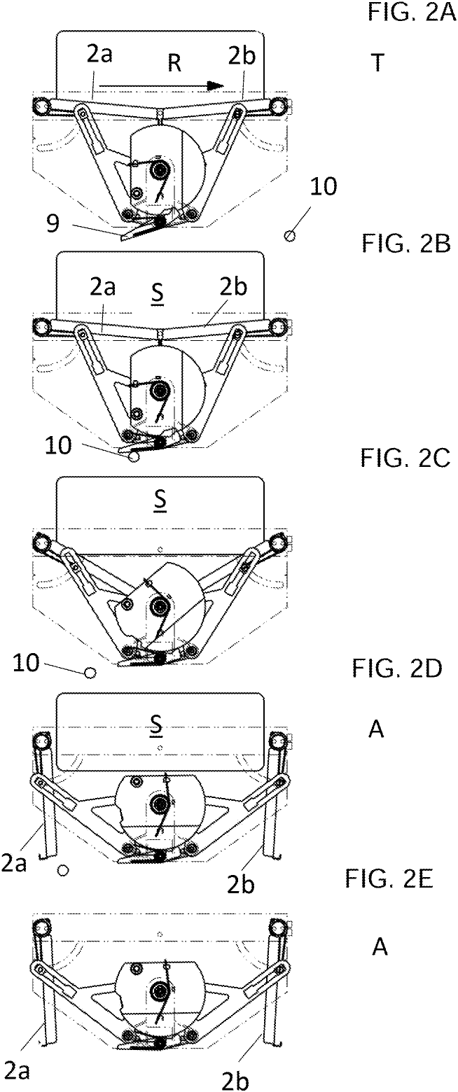

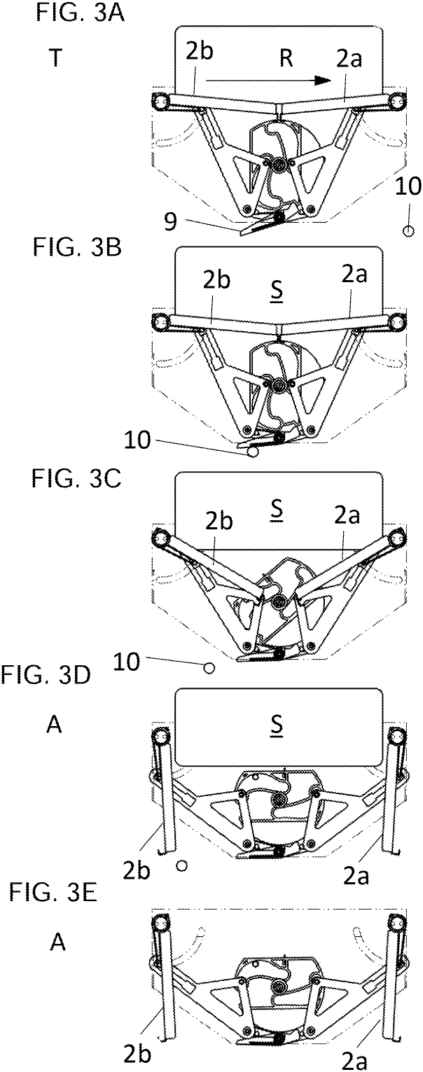

The transport container shown in FIGS. 1A and 1B can be moved from the transport position T shown in FIG. 1A and FIG. 1B to a dropping position A, as shown below with reference to FIGS. 2A-2E and FIGS. 3A-3E, in order to be able to drop a piece good S placed on the surface of the two flaps 2 in the transport position T at an unloading station of the transport and sorting system:

In the transport position T shown in FIG. 2A and FIG. 3A, in which a piece good S is located on the upper side of the two closed flaps 2, the transport container is moved in the transport direction R along a transport path of the transport and sorting system. A release element 10 movable by an actuator not shown between a passive normal position and an active functional position is arranged on the transport path. When the release element 10 is in its active functional position, the release element 10 engages the transport way of the transport container along the transport path and comes into contact with the latch 9 when the transport container passes the release element 10, as shown in FIG. 2B and FIG. 3B. As the transport container passes the release element 10, the downwardly projecting end portion of the latch 9 is pushed upward by the release element 10, causing the latch 9 to rotate and move out of the notch 16 on the outer circumference of the cam plate 5. As a result, the cam plate 5 is unlocked and starts rotating in a first direction of rotation due to the pretensioning of the cam plate 5 by the tensioning or spring element 8. The first direction of rotation is clockwise when viewed from FIG. 1A and counterclockwise when viewed from FIG. 1B.

FIG. 2C and FIG. 3C show an intermediate position in which the cam plate 5 has already moved by an angle of approx. 45° from its basic position. When the cam plate 5 rotates, the guide rollers 11 of the two adjusting levers 4a, 4b each roll on the associated guide surface 6a or 6b of the cam plate 5. The rotary movement of the cam plate 5 causes the guide section 4′ of the two adjusting levers 4a, 4b to move radially outwards in each case, as viewed from the cam plate 5, as a result of which the pins 22 on the underside of the two flaps 2a, 2b run downwards and outwards in the partially circularly curved elongated slot 21 on the one hand and downwards in the straight elongated slot 20 of the longitudinal section 4′ of the respectively associated adjusting lever 4a, 4b on the other hand. This moves the respective flap 2a, 2b from its closed position to an intermediate position, as shown in FIG. 2C and FIG. 3C.

When the cam plate 5 is further rotated to the end position shown in FIG. 2D and FIG. 3D, both flaps 2a, 2b are fully opened. In this end position of the flaps 2, which represents the dropping position A, the two flaps 2a, 2b are approximately in a vertical direction and the pins 22 on the underside of each of the flaps 2a, 2b rest against the lower/outer end of the curved elongated slot 21.

The guide rollers 11 of the first adjusting lever 4a and the second adjusting lever 4b have moved along the curved guide section 6′ of the first and second guide surfaces 6a, 6b, respectively, into the first holding section 6″ of these guide surfaces. In the end position of FIG. 2D and FIG. 3D, in which the two flaps 2a, 2b are in their dropping position A, the guide rollers 11 of the first adjusting lever 4a and of the second adjusting lever 4b are in contact with the first holding section 6″ of the first guide surface 6a and of the second guide surface 6b, respectively, as can be seen in FIG. 2D and FIG. 3D. During the movement of the two flaps 2a, 2b from their transport position T (which is shown in FIG. 2A and FIG. 3A) to their dropping position A (which is shown in FIG. 2D and FIG. 3D), the guide rollers 11 of the first adjusting lever 4a and of the second adjusting lever 4b rest respectively on the associated guide surface 6a, 6b of the cam plate 5 and are thereby guided by the cam plate 5. As a result of the movement of the two flaps 2a, 2b from the closed position (transport position T according to FIG. 2A and FIG. 3A) to their open position (dropping position A, according to FIG. 2D and FIG. 3D), the piece good S resting on the upper side of the two flaps 2a, 2b in the transport position T falls downwards due to the force of gravity and is thereby dropped from the transport container into a collecting container located in an unloading station below the passing transport container, as shown in FIG. 2E and FIG. 3E. The two flaps 2 are held in the open position by their dead weight and by the bearing of the guide rollers 11 in the holding sections 6″ of the guide surfaces 6a, 6b.

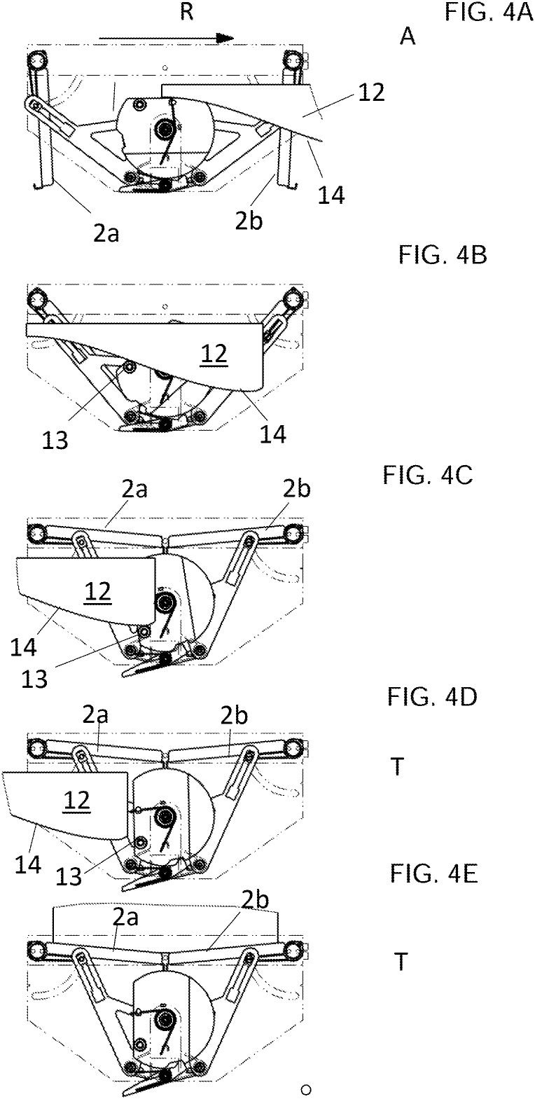

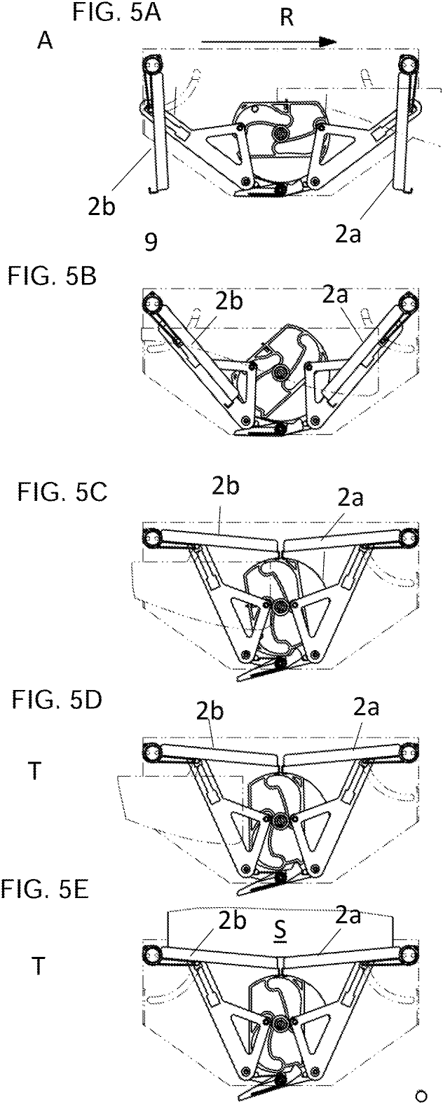

While the piece good S is being discharged from the transport container, the transport container continues to move in the transport direction R along the transport path with the flaps 2a, 2b open. After the piece good S has been dropped at an unloading station, the transport container is returned from its dropping position A to its transport position T by closing the two flaps 2a, 2b. The closing of the flaps 2 is explained below with reference to FIGS. 4A-4E and FIGS. 5A-5E.

To close the flaps 2, a sliding block guide is provided on the transport path with a sliding block 12 that has a ramp with an inclined and/or curved stop surface 14. The sliding block 12 is arranged on the transport path downstream of one or each unloading station and projects into the transport path of the transport container to such an extent that the stop surface 14 of the sliding block 12 comes into contact with the stop element 13 of the cam plate 5 when the transport container moves past the sliding block 12 in the transport direction R, as shown in FIGS. 4A and 5A and FIGS. 4B and 5B. When the stop surface 14 of the sliding block 12 comes into contact with the stop element 13 of the cam plate 5, as shown in FIG. 4B and FIG. 5B, the cam plate 5 is set in rotation in a second direction of rotation. The second direction of rotation is opposite to the first direction of rotation when the flaps are opened and points counterclockwise in the view of FIG. 1A. The rotation of the cam plate 5 in the second direction of rotation causes the guide rollers 11 of the two adjusting levers 4a and 4b to roll on the respective associated guide surface 6a, 6b of the cam plate 5, as a result of which the adjusting levers 4a, 4b are raised and the two flaps 2a, 2b are pivoted upwards from their open position. FIG. 4B and FIG. 5B show an intermediate position of the two flaps 2a, 2b.

The cam plate 5 is rotated by the sliding block 12 in the second direction of rotation until it has reached its normal position. It is expedient for the sliding block 12 to then turn the cam plate slightly beyond its normal position, as shown in FIG. 4C and FIG. 5C. As soon as the cam plate 5 is in its basic position, the pretensioned latch 9 engages in the notch 16 on the outer circumference of the cam plate 5, locking the cam plate 5 in its basic position. In this position of the cam plate, the two flaps 2a, 2b are in their transport position T and the guide rollers of the two adjusting levers 4a, 4b each rest against the further holding section 6″ of the respective associated guide surface 6a, 6b, as shown in FIG. 4D and FIG. 5D. As a result, the flaps 2a, 2b coupled to the control levers 4a, 4b are held in their transport position T.

During the entire movement of the flaps 2a, 2b from the dropping position A (shown in FIG. 4A and FIG. 5A) to the transport position T (shown in FIGS. 4D and 5D and FIGS. 4E and 5E), the guide rollers 11 of the two adjusting levers 4a, 4b are guided on the respective associated guide surface 6a, 6b of the cam plate 5. When the two flaps 2a, 2b are raised, the pins 22 arranged on the underside of the flaps are guided upwards in the curved elongated slot 21 of the support frame 1 until the two flaps 2a, 2b are in their closed position, in which the flaps have at least a substantially horizontal position and are ready to receive a piece good S (as shown in FIG. 4D and FIG. 5D). In the transport position T, the transport container can then be reloaded with a piece good S at a subsequent loading station in the transport direction R, as shown in FIG. 4E and FIG. 5E.

The transport container according to the invention enables safe and gentle opening and closing of the or each flap with a compact design consisting of few components and with low noise development. The or each flap can be opened by unlocking and rotating the cam plate within a very fast opening time of 150 ms or less, preferably within less than 100 ms. The flaps can be closed by means of the sliding block in a material-friendly manner over a longer closing time in the range of 300 ms to 500 ms, in particular between 400 ms and 450 ms. The closing time can be adjusted by the length of the sliding block 12, in particular by the extension of the guide surface 14 of the sliding block 12 along the transport direction R and/or by the inclination of the guide surface 14.

1. A transport container for a sorting device, the transport container comprising a support frame, at least one flap pivotably arranged on the support frame and an adjusting device which is coupled to the at least one flap in order to move the at least one flap between a transport position for transporting a piece good and a dropping position for dropping the piece good, wherein the adjusting device comprises at least one adjusting lever coupled to the at least one flap, wherein a cam plate rotatably mounted on the support frame and having at least one guide surface on which the at least one adjusting lever is guided during the entire movement of the at least one flap from the transport position into the dropping position and/or during an entire return movement from the dropping position into the transport position.

2. The transport container according to claim 1, wherein the at least one flap comprises a first flap and a second flap, which are each arranged on the support frame so as to be pivotable about a swivel axis, wherein the at least one adjusting lever comprises a first adjusting lever associated with the first flap and a second adjusting lever associated with the second flap, and wherein the at least one guide surface comprises a first guide surface for guiding the first adjusting lever and a second guide surface for guiding the second adjusting lever.

3. The transport container according to claim 1, wherein the cam plate is preloaded in a basic position by a tensioning element or a spring element, the at least one flap being in the transport position in the basic position of the cam plate.

4. The transport container according to claim 1, wherein the cam plate is held in a basic position by a securing element, the at least one flap being in the transport position in the basic position of the cam plate.

5. The transport container according to claim 4, wherein a releasing element releases the securing element when the transport container moves past the releasing element in an intended transport direction, the releasing element being arranged on a transport path of the sorting device upstream of an unloading station at which the transport container discharges the transported piece good by moving the at least one flap into the dropping position and/or wherein the release element is designed as a movable pin and is movable from a passive normal position into an active functional position.

6. The transport container according to claim 1, wherein the at least one adjusting lever has a guide element, which during the entire movement of the at least one flap from the transport position into the dropping position and/or during a complete return movement from the dropping position into the transport position bears against the at least one guide surface.

7. The transport container according to claim 1, wherein the at least one guide surface is formed by a protrusion or a recess on a surface of the cam plate or on an outer circumference of the cam plate and/or wherein the at least one guide surface is part of a recess or an opening in the cam plate.

8. The transport container according to claim 1, wherein the at least one guide surface comprises a guide area and a holding area, the guide area being convexly curved and the holding area being of part-circular shape and set back with respect to the guide area, wherein a guide element arranged on the at least one adjusting lever rests against the guide area of the guide surface during movement of the at least one flap from the transport position into the dropping position and is located in the holding area of the guide surface in the dropping position.

9. The transport container according to claim 1, wherein a sliding block cooperates with a stop element arranged on the cam plate for moving the at least one flap back from the dropping position into the transport position.

10. The transport container according to claim 9, wherein the sliding block is arranged on a transport path of the sorting device downstream of an unloading station, at which the transport container drops the transported piece good by moving the at least one flap into the dropping position and/or wherein the stop element is arranged eccentrically on the cam plate.

11. The transport container according to claim 9, wherein the sliding block has a ramp with a stop surface which is inclined or curved relative to a horizontal plane and against which the stop element of the cam plate comes to rest, when the transport container moves past the cam plate in an intended transport direction and/or wherein the cam plate is set in rotation by interaction of the cam plate and the stop element when the transport container moves past the cam plate in an intended transport direction.

12. A sorting device comprising at least one transport container according to claim 1.

13. A method for opening and/or closing a transport container for a sorting device, the transport container comprising a support frame, at least one flap pivotably arranged on the support frame, and at least one adjusting lever which is coupled to the at least one flap, the method comprising:
moving the at least one flap from a transport position for transporting a piece good into a dropping position for dropping the piece good or back, by rotating a cam plate rotatably mounted on the support frame and having at least one guide surface, the at least one adjusting lever being guided on the guide surface during the entire movement of the flap from the transport position into the dropping position and/or during the entire return movement from the dropping position into the transport position.

14. The method according to claim 13, wherein for opening the transport container the cam plate, which is preloaded and/or locked in a basic position, is unlocked, as a result of which the cam plate is automatically set in rotation in a first direction of rotation and the at least one flap is moved from the transport position into the dropping position due to the coupling of the flap to the at least one adjusting lever and the guiding of the adjusting lever on the at least one guide surface.

15. The method according to claim 13, wherein for closing the transport container, the cam plate is set in rotation in a second direction of rotation opposite to the first direction of rotation by a sliding block engaging on an eccentric stop element of the cam plate, and the at least one flap is moved from the dropping position into the transport position as a result of the coupling with the at least one adjusting lever and the guidance of the adjusting lever on the at least one guide surface.

16. The transport container according to claim 1, wherein the sorting device is a split tray sorter.

17. The transport container according to claim 2, wherein the swivel axis is perpendicular to an intended transport direction.

18. The transport container according to claim 4, wherein the securing element is a preloaded latch.

19. The transport container according to claim 5, wherein the releasing element is movable by magnetic actuation from the passive normal position into the active functional position.

20. The transport container according to claim 6, wherein the guide element is a guide roller.
